(19) United States
(12) Patent Application Publication
(10) Pub. No.: US 2025/0250375 A1
(43) Pub. Date: Aug. 7, 2025

(54) TECHNIQUE FOR THE IMPROVEMENT OF BROADBAND (500 MHZ - 50 GHZ) DIELECTRIC COEFFICIENT OF PMMA / BORAX COMPOSITE SYNTHESIZED BY ATRP METHOD AND ITS HYDROPHILIC PROPERTIES MODIFIED AND POTENTIAL APPLICATION AREAS

(71) Applicant: ISTANBUL TEKNIK UNIVERSITESI, Istanbul (TR)

(72) Inventors: Nilgun BAYDOGAN, Istanbul (TR); Murat CELEP, Istanbul (TR); Fuat Berke GUL, Istanbul (TR)

(73) Assignee: ISTANBUL TEKNIK UNIVERSITESI, Istanbul (TR)

(21) Appl. No.: 18/852,535

(22) PCT Filed: Mar. 27, 2023
(86) PCT No.: PCT/TR2023/050287

§ 371 Date: Sep. 30, 2024

(30) Foreign Application Priority Data
Mar. 29, 2022 (TR) 2022/004865

(51) Int. Cl. C08F 220/14; B01J 23/72; C08K 3/38; H01Q 1/42

(52) U.S. Cl. CPC C08F 220/14; B01J 23/72; C08K 3/38; C08F 2438/01; C08K 2003/387; H01Q 1/42

(57) ABSTRACT

The provided is a PMMA (polymethylmethacrylate) and borax doped copolymer synthesized by using atom transfer radical polymerization (ATRP) method, and uses of this copolymer. The steps of the method include: filling an Atmos-Bag with argon gas; and weighing of Tetra-n-butylammonium Bromide, Copper Bromide, Borax Decahydrate, Methyl Methacrylate, Pentamethyldiethylenetriamine, Ethyl 2-bromoisobutyrate chemicals with a precision scale in the Atmos-Bag.

### CROSS-REFERENCE TO THE RELATED APPLICATIONS

This application is the national phase entry of International Application No. PCT/TR2023/050287, filed on Mar. 27, 2023, which is based upon and claims priority to Turkish Patent Application No. 2022/004865, filed on Mar. 29, 2022, the entire contents of which are incorporated herein by reference.

### TECHNICAL FIELD

The invention relates to a PMMA (polymethylmethacrylate) and borax doped copolymer synthesized by using atom transfer radical polymerization (ATRP) method, and fields of application of this copolymer.

### BACKGROUND

Poly (methyl methacrylate) (PMMA) is a thermoplastic polymer with high strength and heat resistance, good mechanical properties and high abrasion resistance. PMMA has high optical transmittance, it is also resistant to ultraviolet rays and weathering. Thanks to such properties, it is frequently used in food industry, health applications, automotive and aircraft industry, ultraviolet ray and radiation shielding applications. PMMA composites are produced in order to increase the positive properties of PMMA, to spread it to a wider area of use or to place it in specialized use in certain areas. Poly (methyl methacrylate) (PMMA) is a thermoplastic polymer with high strength and heat resistance, good mechanical properties and high abrasion resistance [1].

ATRP, in situ dispersion polymerization, Pickering emulsion polymerization, melt mixing, addition polymerization, free radical polymerization, anionic and cationic polymerization techniques are some of the PMMA polymer synthesis methods.

In the known state of the art, in the master's thesis published in January 2020 with thesis number 611170, the synthesis of PMMA/borax doped copolymer using the ATRP method is mentioned. Borax powder was added into the PMMA solution.

In known state of the art, paper with DOI number 10.5281/zenodo.4084573, borax powder doped PMMA copolymer synthesized by ATRP method is mentioned.

In the known state of art, international patent document numbered WO2021018422A1, synthetic polymers that transmit radio frequency for the purpose of decorative coating of radomes are mentioned. Polymers such as PMMA, polypropylene, polyurethane are mentioned as appropriate materials that can be used in radome.

In the known state of art, international patent document numbered WO2020179358A1, materials that can be used as radomes in radar devices are mentioned. It is mentioned that materials such as PMMA, polycarbonate, polyethylene, polypropylene are suitable materials that can be used in the radome and also that these polymers may contain additives.

However, borax powder was used in the composite polymers in the sample patent documents. The use of borax powder does not show a good dispersion property in the polymer solution. In the present invention, PMMA/Borax copolymer containing crystalline borax was synthesized. Due to its good dispersion properties, it was able to provide physical properties that can be used for radome purposes.

In the known state of the art, there is no synthesis of a PMMA polymer with sufficiently low dielectric properties in broadband, hydrophilic properties and properties suitable for use in radome. Polymers synthesized with low dielectric properties suitable for use in broadband within the framework of the methods used before the invention in question do not have sufficient smoothness and hydrophilic properties on their surfaces.

Therefore, there is a need to use the copolymer obtained by improving the broadband (500 MHz-50 GHz) dielectric coefficient of the PMMA/borax composite with modified hydrophilic properties synthesized by the inventive ATRP method for radome purposes.

### SUMMARY

The aim of the present invention is to realize the copolymer obtained by improving the broadband (500 MHz-50 GHz) dielectric coefficient of PMMA/borax composite synthesized by ATRP method and modified with hydrophilic properties in order to be used as a radome.

Another purpose of the present invention is to realize a hydrophilic PMMA/borax composite copolymer with modified hydrophilic properties synthesized by ATRP method in order to provide self-cleaning feature (by synthesizing it with borax, which is an active ingredient in surface cleaners) and to obtain sufficient smoothness and hydrophilic properties on the surfaces of polymers. Another purpose of the present invention is to provide a PMMA/borax composite copolymer synthesized by the ATRP method with low dielectric coefficient properties suitable for use in a wide broadband range.

### BRIEF DESCRIPTION OF THE DRAWINGS

Images of the hydrophilic properties modified PMMA/borax composite copolymer synthesized by the ATRP method to achieve the purposes of the present invention are shown in the attached figures.

These figures are; εᵣ

FIG. 1: Graph showing the variation of the dielectric modulus Er depending on the frequency.

FIG. 2: Graph showing the creation of the fit curve according to the values measured from the dielectric Er coefficient of PMMA/borax composite doped with 10 wt % borax.

FIG. 3: Graph showing the dielectric coefficient of PMMA/borax composite recalculated with the equation derived from the fit curve generated from the dielectric coefficient Er.

FIG. 4: Graph showing the tangent loss values of the synthesized dielectric material at different borax concentrations.

FIG. 5: Graph showing the Shore-D values of borax reinforced PMMA composite synthesized by ATRP method to create low dielectric properties in a wide frequency range (500 MHz-50 GHz).

FIG. 6: Graph showing the Contact Angle Measurement results and drop shapes of the samples (2 wt %, 5 wt %, 7.5 wt % and 10 wt % PMMA/borax and undoped PMMA) synthesized by ATRP method to create low dielectric properties in a wide frequency region (500 MHz-50 GHz).

FIG. 7: Graph showing the X-band electromagnetic wave transmission coefficient of 2 wt %, 5 wt % and 10 wt % PMMA/borax and undoped PMMA.

### DETAILED DESCRIPTION OF THE EMBODIMENTS

The developed polymer includes elements of;
PMMA (polymethylmethacrylate)
Crystalline-grained borax (sodium borate decahydrate).

Components used in the synthesis method of borax-doped PMMA polymer;
Methyl Methacrylate (MMA) as the monomer,
Copper Bromide (CuBr) as the catalyst,
Tetra-n-butylammonium Bromide (C₁₆H₃₆BrN), as the solvent,
Ethyl 2-Bromoisobutyrate (EBIB, C₆H₁₁BrO₂), as reaction initiator,
1,1,4,7,7-Pentamethyldiethylenethylenetriamine (PMDETA, C₉H₂₃N₃), as ligand,
Crystalline-grained Borax Decahydrate (Na₂B₄O₇·10H₂O) as an additive

The developed method includes the following process steps,
filling the two-handed Atmos-Bag with argon gas,
Weighing of Tetra-n-butylammonium Bromide, Copper Bromide, Borax Decahydrate, Methyl Methacrylate, Pentamethyldiethylenetriamine, Ethyl 2-bromoisobutyrate chemicals with the precision scale in Atmos-Bag,
Mixing crystalline Borax Decahydrate and monomer Methyl Methacrylate in Atmos-Bag,
adding Tetra-n-butylammonium Bromide as the solvent and Copper Bromide as a catalyst into a mixture of crystalline Borax Decahydrate and monomer Methyl Methacrylate and stirring in Atmos-Bag,
removing the mixture from the Atmos-Bag and transferring it to another Atmos-Bag filled with argon gas,
Adding the pentamethyldiethylenetriamine ligand,
applying argon gas to the solution with a syringe for 30 minutes to carry out the purification process, adding Ethyl 2-bromoisobutyrate reaction initiator to the mixture,
stirring until polymerization is complete using a magnetic stirrer and bar to ensure effective stirring during the reaction,
obtaining PMMA/Borax composite polymer as a result of the polymerization process,

Borax is available in two different forms: crystalline granules or powder forms. In case borax is used as a filler, it has been determined that the use of borax in powder crystalline form (particle size less than 500 μm) affects the synthesis step and the PMMA/Borax composite obtained as a result of the developed method synthesized by the ATRP method causes changes in physical properties that are not suitable for radome use.

In the developed method, the solvent Bu4NBr and the Borax Decahydrate particles used as filler were thoroughly contacted with the solution in the test tubes in a single mixing device without using a new second mixing device for thorough contact of these particles with the solution, so that all surfaces were in contact with the solution. Thus, a shorter contamination time to the solution was ensured. Because, by ensuring proper mixing of the Borax Decahydrate particles, maximum contact of the solution between the particles was provided and the contamination of the solution between the solvent Bu₄NBr. The use of the catalyst CuBr has developed effectively the integration of the Borax Decahydrate in the solution. Thus, the PMMA/Borax composite polymer developed was effective in developing superior physical properties for radome use.

The use of crystalline grains in the synthesis method of the developed PMMA/Borax composite polymer has led to differences in the ability of the solution to provide adequate contamination, as they show different dispersion behaviors in the PMMA solution. As a result, the synthesis of crystalline grains and powdered Borax Decahydrate structures resulted in dramatic changes in the final product properties.

In the synthesis method of PMMA/Borax composite polymer, the synthesis steps became more practical if the Borax crystal grains were in the range of 1.18-0.063 mm. Thus, the rotary mixer used in the known state of the art was not required. Thus, in the synthesis method of the developed PMMA/Borax composite polymer, the electrical conductivity was improved by increasing the free electrons in the dielectric composite structure and a material suitable for radome use was synthesized.

The PMMA/Borax composite polymer obtained with the developed method is developed to improve the dielectric properties of the PMMA/Borax composite polymer to be suitable for use as a radome for antennas in broadband multimode search, target designation and fire control radars.

One point of structures such as antennas used for wireless communication between two points is usually in variable environmental conditions such as land, sea, submarine, air or space. In order to ensure that the antennas under variable ambient conditions work without being affected by the environment, products called radomes are used, which are resistant to the environment, unresponsive to the communication signal, but have dielectric properties that protect the antenna operating in a wide band range against ambient conditions. However, the requirements of varying environmental conditions are different from each other and it is not possible to use the same radome product under different environmental conditions [2-3]. Therefore, depending on the application conditions, the product used for the radome is selected.

Contact angle measurement is performed to test the surface properties of the invention. With this measurement, it is possible to determine the water holding capacity of the samples, to determine the wettability properties and to understand the hydrophilic-hydrophobic surface properties. The surface contact angle values of PMMA without additives and PMMA/Borax composites containing 2 wt %, 5 wt %, 7.5 wt % and 10 wt % Borax are 80.1°, 79.1°, 79°, 75.6°, and 74.2°, respectively. With the addition of borax, the glass transition temperature of PMMA increases and its thermal strength increases.

Increasing the weight percent (wt %) value of borax and decreasing the contact angle measurement values lead to more hydrophilic surfaces. Borax doping increases the attraction force on the chains on the surface of PMMA, positively affecting the surface energy and increasing the surface energy.

The type and amount of particles used as filler in the existing PMMA structure with the same purpose of use as the invention in question, the increase in agglomeration in the polymer structure, adversely affects the development of surface energy and hydrophilicity. The addition of borax to the PMMA structure increases the optimum roughness and wettability of the surface of the synthesized composite, which is suitable for broadband radome use, and reduces the contact angle values.

In the invention in question, unlike the products known in the art, PMMA/borax polymer, which is suitable for use in broadband and creates differences compared to existing radome products, has been realized by providing low dielectric coefficient at different frequencies in broadband and examining its hardness and hydrophilic properties in detail.

The borax crystal, sodium tetraborate decahydrate, which is used in PMMA cleaning products and detergents, is used in this composite structure. Thus, as a result of the easy flow of water through the PMMA/Borax composite surface, the water forms a thin film layer, solving the problem of ice layer that may form on the surface of the material and the electromagnetic attenuation problem that may be caused by the thick layer of water.

In order to reinforce the developed polymer with surface cleaning agents, borax is added to the PMMA structure and synthesized together, and a PMMA/borax composite structure is formed as a product with improved self-cleaning properties for radome use. Unlike the products known in the art, the material synthesized in the present invention has a smoother, higher hardness and more hydrophilic surface and its dielectric properties are obtained with smaller values compared to its counterparts. The selection of the catalyst (CuBr) used in the synthesis process applied in the ATRP method used in this invention in a way that is most suitable for radome use and the use of Sodium Tetraborate Decahydrate (Na₂B₄O₇·10H₂O) (Borax) as an additive material; the material's wide band operating frequency, the water-loving surface, the development of thermal resistance, and the increase in mechanical strength make the polymer superior.

The amount of transmittance and stable dielectric values against radio and microwaves are determined by the sensitive technique developed with the measurement of the polymer samples created with these new synthesis steps used in the ATRP method in a wide band range and the transmittance and dielectric coefficient.

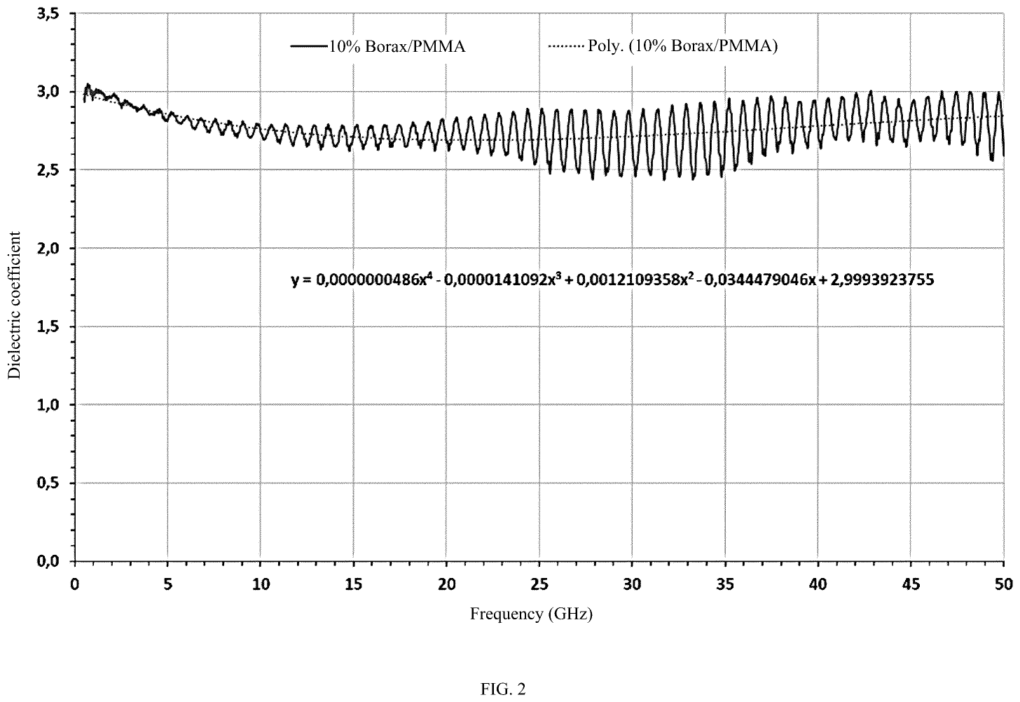

The synthesized undoped PMMA and borax-doped PMMA samples are dielectric materials with a dielectric constant over the entire broadband frequency range (500 MHz-50 GHz). This property allows it to be used as a dielectric material in a capacitor that operates stably over a wide frequency range (FIGS. 2-4). Thus, a low-cost alternative capacitor dielectric material with favorable production conditions is produced. The material proposed in the present invention has low dielectric constants in the X (8.2-12.4 GHZ), Ku (12-18 GHz), K (18-26.5 GHZ) and Ka (26.5-40 GHz) bands and can be used as a dielectric material in systems operating in the said wide band range.

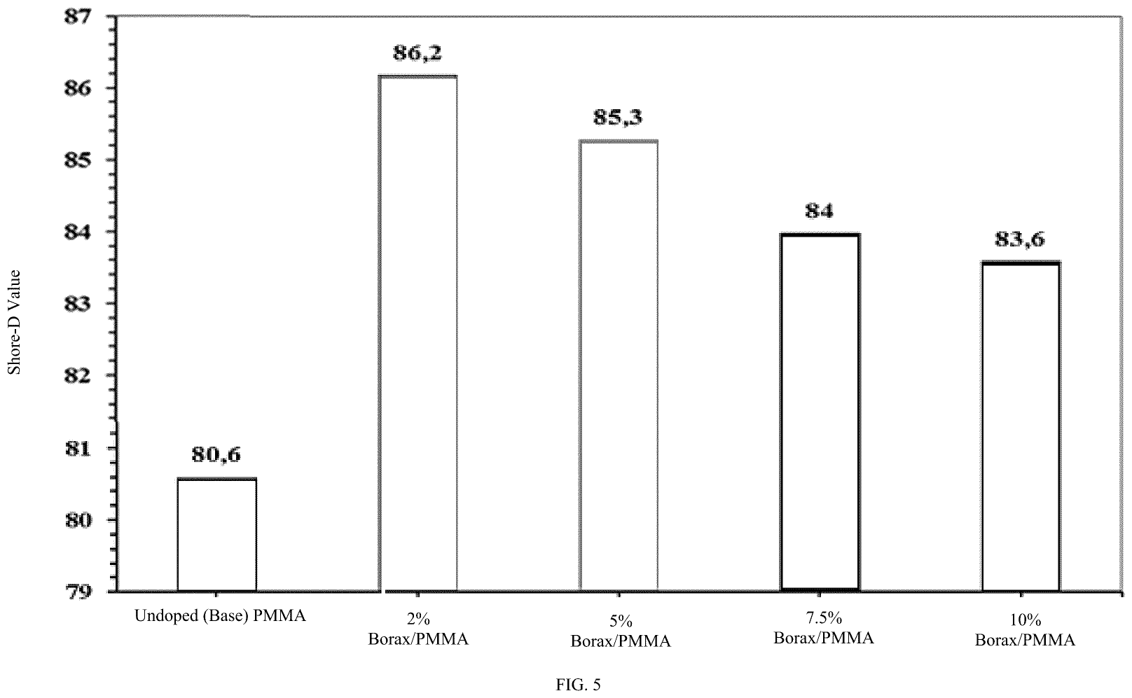

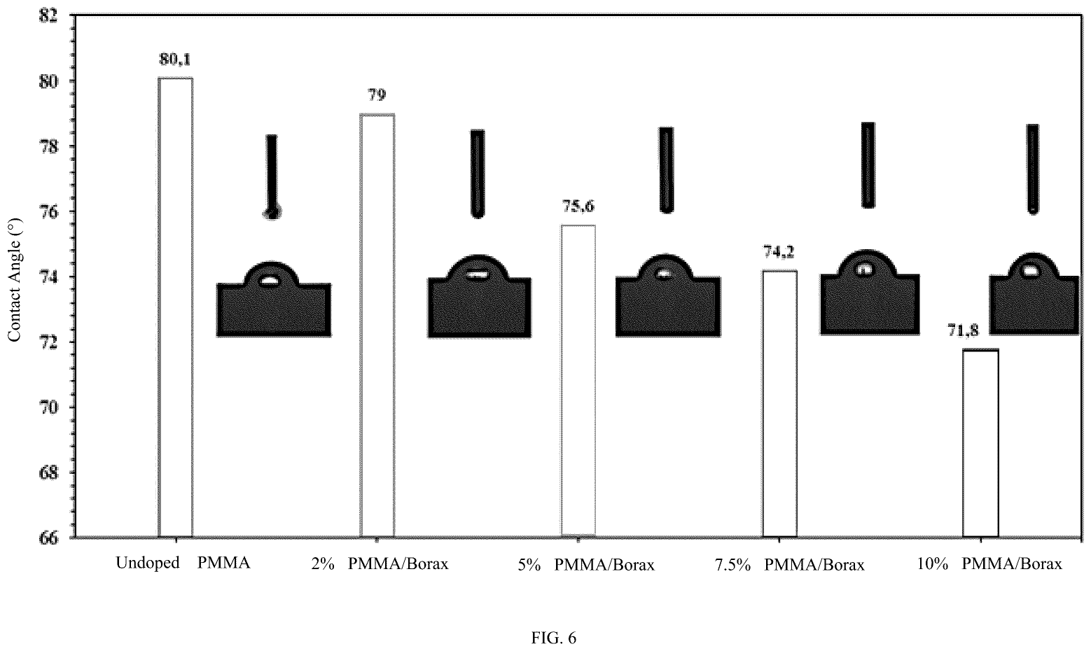

This PMMA/borax polymer material, whose dielectric properties are superior to other antenna coating polymers used as radomes in the industry, can serve as protection for antennas used in land, sea and air platforms and space studies thanks to its improved temperature, ultraviolet (UV), weather and atmospheric conditions resistance, armoring against beta particles, increased hardness (FIG. 5), mechanical properties (Table 1) and modified hydrophilic surface properties (FIG. 6).

TABLE 2
This table shows the mechanical properties of PMMA/borax
composite synthesized by ATRP method with different borax
amounts as a thermoplastic with low dielectric properties
for use as a radome, calculated with sound velocity values
measured with normal probe and angled probe.

| | | Young's | Shear | | Bulk |
|---|---|---|---|---|---|
| | | Module | Module | Micro- | (Volume) |
| | Poisson's | (E) | (G) | hardness | Module |
| Examples | Ratio (v) | [GPa] | [GPa] | [GPa] | [GPa] |
| Undoped | 0.359 | 5.185 | 1.907 | 0.179 | 6.141 |
| PMMA | | | | | |
| %2 Borax/ | 0.359 | 5.400 | 1.986 | 0.186 | 6.395 |
| PMMA | | | | | |
| %5 Borax/ | 0.358 | 5.585 | 2.054 | 0.193 | 6.615 |
| PMMA | | | | | |
| %7.5 Borax/ | 0.343 | 5.977 | 2.199 | 0.206 | 7.079 |
| PMMA | | | | | |
| %10 Borax/ | 0.348 | 6.234 | 2.293 | 0.215 | 7.383 |
| PMMA | | | | | |

In determining the development of hardness values of PMMA/borax composite with borax reinforcement, class D Shore-D test, which is suitable for polymers, is performed. Borax reinforcement causes an increase in the Shore-D values of PMMA synthesized by the ATRP method to create low dielectric properties in the broadband (FIG. 5).

Normal probe and angled probes are used to determine the elastic properties of PMMA/borax composite, which is synthesized by ATRP method with different borax amounts as a thermoplastic with low dielectric properties for use as a radome, by ultrasonic testing method. The mechanical properties of PMMA/borax composite, calculated by longitudinal and transverse sound wave velocity values obtained by ultrasonic testing method, are used to calculate Young's Modulus, Poisson's Ratio, Volume Module, Microhardness and Shear Module (Table 1). The increase in borax content in PMMA causes an increase in Young's Modulus, Shear Modulus, Modulus of Volume and Microhardness values and decreases Poisson's ratio. The increase in Young's Modulus and Shear Modulus indicates an increase in resistance to both compression and shear force by increasing resistance to stretching and elastic deformation. With the increase in Shear Modulus, the polymer composite in this patent application becomes more rigid. The increase in hardness in the Shore-D results (FIG. 5) is consistent with the increase in microhardness calculated using the velocities of the transverse and longitudinal waves (Table 1). The elastic properties determined by ultrasonic testing indicate an increase in the compressive and force resistance of the borax-reinforced PMMA composite and an increase in the resistance to plastic deformation of the structure.

Borax doping in the PMMA/borax composite synthesized by the ATRP method enables the modification of the hydrophilic properties of the surface structure of PMMA (FIG. 6). The contact angle results show that water drops contact the PMMA surface with an angle value of 80.1°, while this value decreases to 74.2° with borax doping. Borax doping leads to slightly increased surface roughness and hydrophilicity (FIG. 6) of PMMA. As the doping amount increases, the surface becomes more hydrophilic. The PMMA/borax composite synthesized by ATRP method as a material with improved properties such as self-cleaning, low dielectric properties against electromagnetic waves in the wide bandwidth range, increased hardness (FIG. 5) and mechanical performance (Table 1) makes it a superior and competitive thermoplastic product for use as a radome.

PMMA/borax polymer composite samples are synthesized by ATRP method which is one of the living polymerization methods. The chemicals used are C5H802 Methyl Methacrylate (MMA) as monomer, CuBr Copper Bromide as catalyst, C₁₆H₃₆BrN Tetra-n-butylammonium Bromide (Bu₄NBr) as solvent, C₆H₁₁BrO₂ Ethyl 2-bromoisobutyrate (EBIB) as initiator, C₉H₂₃N₃ 1,1,4,7,7-Pentamethyldiethylenetriamine (PMDETA) as ligand and Borax Decahydrate (Na₂B₄O₇·10H₂O) was used. The Atmos-Bag with two hand inlets is filled with argon gas and the chemicals are prepared for production. There is one precision scale in the Atmos-Bag and all chemicals are weighed separately on the precision scale in the two-handed Atmos-Bag. Then, the solvent Bu4NBr and the catalyst CuBr are mixed in the Methyl Methacrylate (MMA) monomer with Borax Decahydrate. All these chemicals in solid form are mixed in an Atmos-Bag with two hand inlets. After the addition of Borax Decahydrate, this mixture is removed from the Atmos-Bag and transferred to another Atmos-Bag filled with argon gas. MMA is then added to the mixture of solid chemicals. Pentamethyldiethylenethylenetriamine (PMDETA) is then added to the mixture. The mixture is degassed in argon. Argon gas is applied to the solution with a syringe for 30 minutes to degas the polymer. Ethyl 2-bromoisobutyrate (EBIB) is then added to this mixture. After EBIB is added to the tubes, the polymerization process starts. A magnetic stirrer with a silicon bath is used to provide better mixing conditions. In order to use the magnetic stirrer more effectively, a magnetic stirrer and fish (bar) are added to the container containing the mixture. The mixture is removed from the Atmos-Bag and the test tube is placed in the stirrer with the mouth closed. This magnetic stirrer is preferred because it keeps the temperature characteristics under control and allows manual adjustment of the temperature. Stirring continues until the polymerization is complete.

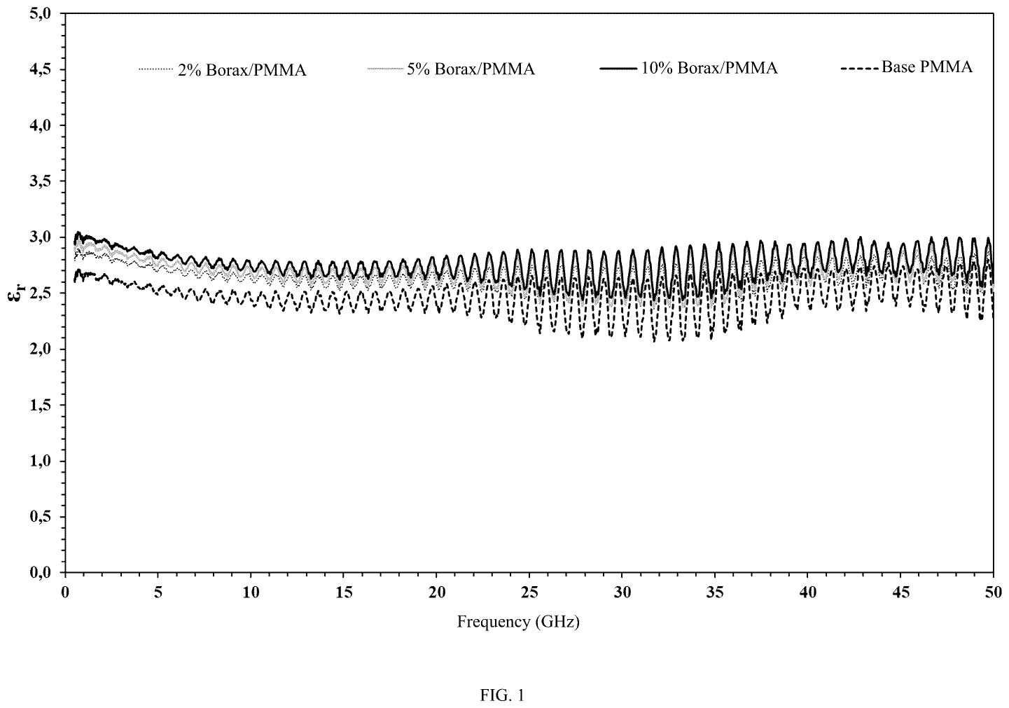

From 500 MHz to 50 GHz, wide frequency measurement results of PMMA/borax composite are obtained by using the reflection measurement method with coaxial probe method using a vector network analyzer (VNA) device (FIG. 1). The VNA device and the equipment used in this measurement are calibrated before the measurement and the error parameters that may arise from the measurement system are eliminated. When the measurement graph in FIG. 1 is created, a frequency-dependent fluctuation occurs in the dielectric coefficient values. As the frequency increases, the amplitude of the fluctuation increases. However, the repetition period remains constant as the frequency increases. The sample thickness used in these measurements is 3 cm and the frequency of the repetition period at this thickness is approximately ˜ 0.7475 GHz.

When measuring with a VNA instrument, the directivity error remains as a parameter, although errors are eliminated by pre-calibration. This value is used metrologically in uncertainty calculations. The amplitude, which repeats itself and increases with frequency, is caused by this directivity and is due to the phase difference between the applied signal and the reflected signal. The phase difference is related to the path the reflected signal takes until it reaches the measurement detector. The wavelength calculation provides information about the value of this directivity error.

The PMMA/borax copolymer in the developed dielectric structure is calculated using the equation

$$λ = \frac{c}{2 \sqrt{{ε}_{r}} f}$$

by taking the path of the electromagnetic wave as it travels in the dielectric, c is the speed of light, 2 is the number of times the signal travels in the material, εᵣ is the dielectric coefficient of the measured material, f is the repetition frequency of the period. When the values of the developed PMMA/borax copolymer are substituted and the equation is run, the quarter wavelength in the developed dielectric structure is determined as ˜3.082 cm. This value is approximately the same as the thickness of the measured sample. Thus, it is determined that the quarter wavelength effect in the developed dielectric structure comes from the measurement system.

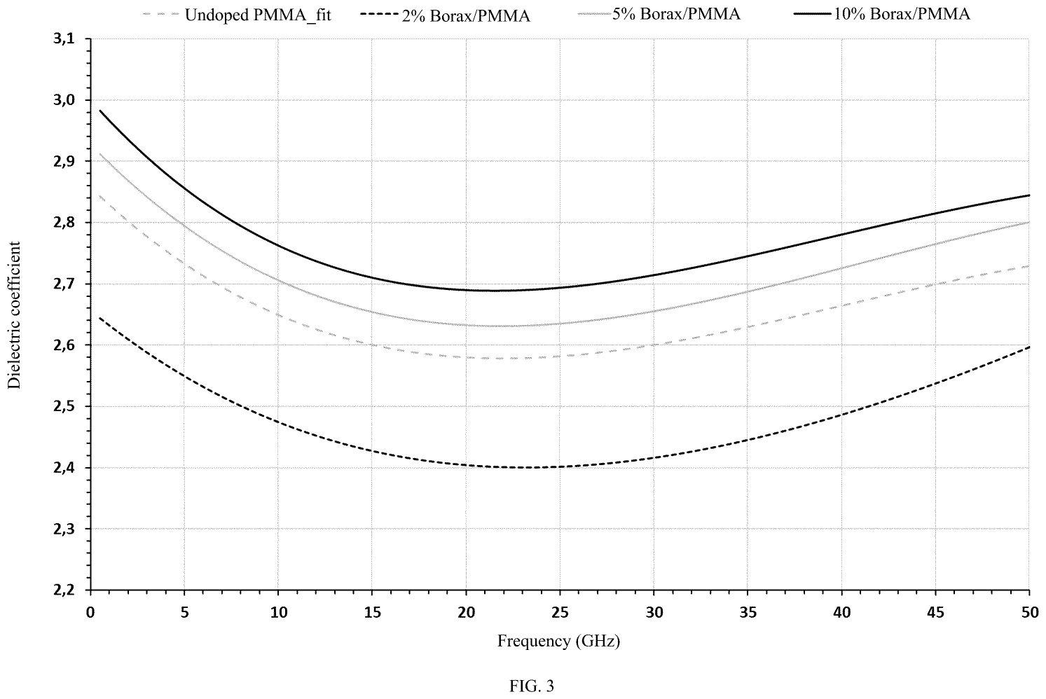

The directivity error of the measurement system is minimized by fitting a curve to the measured values (FIG. 2). A fourth order polynomial fit is applied to the measured values and using the resulting equation, the dielectric constant of the material in this patent application is recalculated and determined (FIG. 3).

When the PMMA/borax composite was compared with undoped PMMA, the dielectric coefficient of PMMA/borax composite doped with 2% borax was found to decrease proportionally by 6.6%. The dielectric coefficients of PMMA/borax composites doped with 5 wt % and 10 wt % were measured as 2.2 and 4.4%, respectively. The average dielectric coefficient values of undoped PMMA, PMMA/borax composite samples doped with 2 wt %, 5 wt % and 10 wt % are 2.47, 2.65, 2.71 and 2.76, respectively.

The average standard deviation of the dielectric coefficients of undoped PMMA and PMMA/borax composites doped with 2 wt %, 5 wt % and 10 wt % PMMA/borax by weight is 2.5% over the frequency bands measured in the range 500 MHz-50 GHz and the variation of the average dielectric coefficient values is very small. The dielectric coefficient of the synthesized samples remains constant at all frequencies and they have a stable structure.

Borax-doped PMMA polymer is applicable to the industry as a dielectric material in capacitor production and as a self-cleaning material with increased hydrophilic properties and increased hardness and strength properties. In terms of its improved properties compared to Plexiglas, it can be applied for industry in all areas of use of both Plexiglas and PMMA, while at the same time, thanks to its dielectric properties, it can also be used in the electronics industry (FIG. 1), internet of things and 5G/6G technology. With the significant development of hydrophilicity, it has a high potential for use in amphibious applications and self-cleaning systems, as well as in cost-effective applications. Similar to optical transmittance, microwave transmittance allows them to be used in satellite, communication and electronics fields where high transmission and low reflectivity are required. Due to the high and low temperature resistance, radiation resistance against proton, neutron, beta particles and X and Gamma rays, armor against ionizing radiation, high strength and good electromagnetic wave transmittance in a wide frequency range (500 MHz-50 GHz) required for antennas used in spacecraft communication, this invention can be used as coating material in antennas or transmitters of agricultural vehicles, spacecraft, probes and telescopes. Considering the systems where microwave radiation is used, the invention helps in the transmission of these radiation thanks to its high microwave transmittance. Especially in Internet of Things (IoT) applications where information transfer, system temperature and performance are of great importance, the invention produced in this study can be used both in data transfer and in reducing the heating problem. It can be added to structures where energy systems are used with applications such as IoT and artificial intelligence, and can provide high performance as a protector for information carriers with light weight and improved mechanical performance.

iii. Tangent Loss

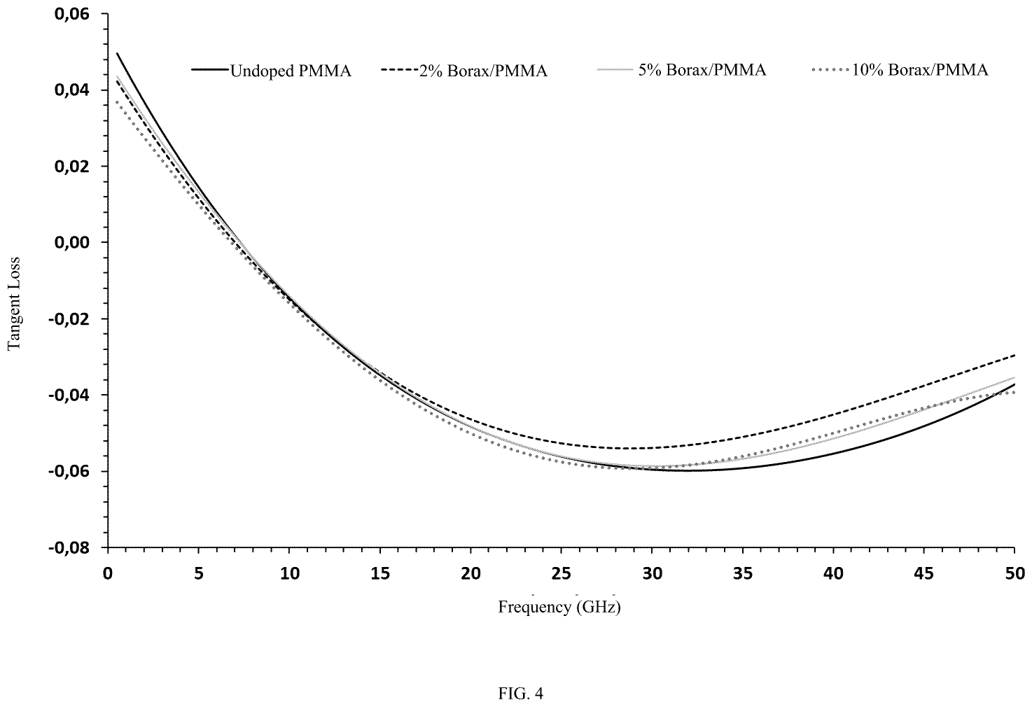

Besides the magnitude of the relative dielectric loss, another important parameter for PMMA/borax composite is the tangent loss. The relative dielectric loss is a mathematically complex quantity and the tangent loss is the ratio of the imaginary part of the relative dielectric loss to the real part and is expressed as the frequency dependent loss of this composite. The error correction technique from this measurement system is also applied to the tangent loss. The tangent loss values obtained for each synthesized sample are shown in FIG. 4. The frequency dependencies of the tangent losses of the synthesized materials in the measurements are given. In FIG. 4, the value of the tangent loss, depending on the frequency, approaches zero and takes a value below zero after approximately 7 GHz. This indicates that the material gets rid of the frequency dependent capacitive effect and shows inductive effect. Considering the synthesized materials, no inductive effect is expected and this effect is due to the measurement method and methodology. When the frequency-dependent effect of the relative dielectric coefficient and capacitive effect is analyzed, the lowest measured value is considered the most accurate value. For all materials disclosed in this patent application, the frequency dependent effect of the relative dielectric coefficient and capacitive effect is on average 0.043 at a frequency of 500 MHz.

The determination of the capacitance value of the PMMA/borax composite with dielectric properties is calculated using the equation

$$C ( f ) = {{C}_{0} ( j \frac{f}{{f}_{0}} )}^{k} .$$

This capacitance value which is related to the relative dielectric coefficient, a mathematically complex number expressed as real (real, Re) and imaginary (imaginary, Im). Here, C(f) is the capacitance value as a function of frequency f. C₀ is the capacitance value at a given frequency f₀. j is the square root of minus one. k is a small negative constant that determines the rate of degradation in C and is determined by k=−teta·(2/π). This provides the optimum tangent loss value of the material in this patent application (suitable for use as a radome material).

In the synthesis of PMMA/borax composite solution by ATRP method, the homogeneous distribution of borax particles in PMMA ensures minimum storage or absorption of electromagnetic waves in the structure by providing the optimum tangent loss value in this dielectric structure, suitable for use in manned and unmanned aerial platforms in satellite communications.

iv. X-Band Transmission Coefficient

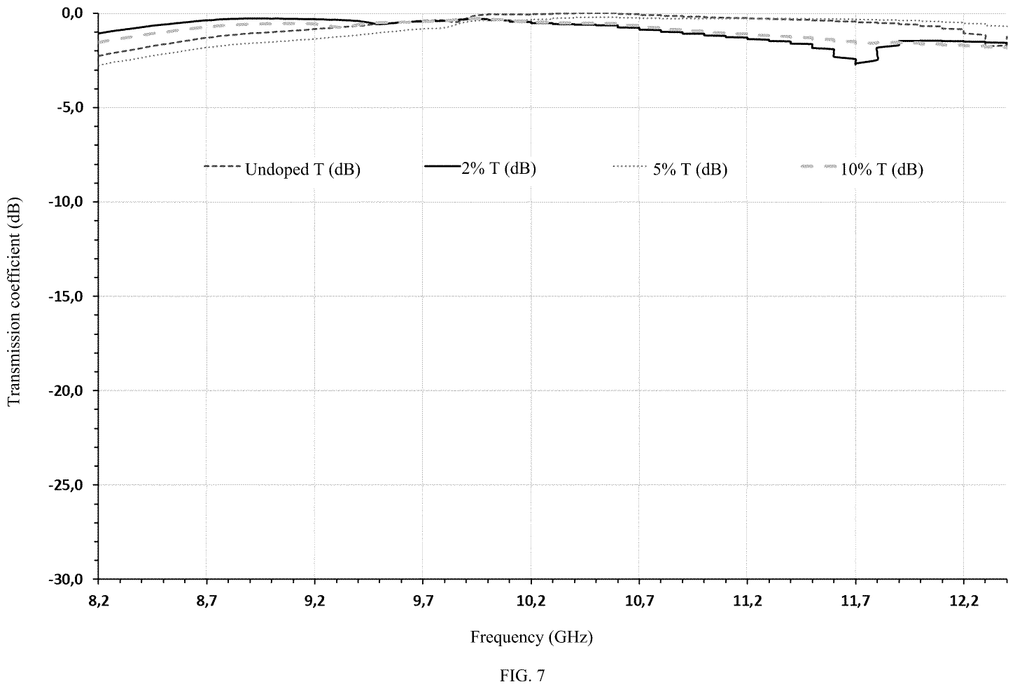

The X-band (8.2 GHz-12.4 GHZ) guided wave method is used to analyze the behavior of PMMA-based materials under microwave signal. One sample of each material is measured using a pre-calibrated vector network analyzer (VNA). The results of the transmission coefficient measurements are presented in logarithmic form in FIG. 7 and show that all materials have losses below 3 dB along the X-band. The lowest transmission loss, averaging 1.8 dB along this band, is obtained from the composite synthesized with 10 wt % borax additive. The average transmission loss values of the other materials are between 2.25 dB and 2.74 dB, and the electromagnetic wave loss of the PMMA/borax composite in this patent application is small. In a potential radome application, an X-band microwave signal passing through the material is transmitted to the other side with a maximum attenuation of 2.74 dB. When the dielectric coefficients subject to the patent and given in FIG. 3 are examined, the dielectric coefficient, which is constant throughout the frequency in the wide band range, means that the speed of all frequencies passing through the material is affected at the same rate and there will be no phase delays between the frequencies. In this case, in the transmission of a signal with a certain modulation, the distortion between frequencies in the signal passing through the material to the receiver is negligible.

The advantages obtained with the developed PMMA/borax composite copolymer are listed below.

It has a stable dielectric coefficient over a fairly wide frequency range (500 MHz-50 GHz).
It has a smooth surface.
It has high temperature resistance.
It operates in a wide temperature range (−60° C. to +230° C.).
It can self-clean.
It is salt and corrosion resistant.
It is resistant to the radiation environment in the Van Allen radiation belts, the radiation belts of the world.
It is resistant to space radiation.
It enables use in applications in harsh operating conditions such as marine vessels, submarines, manned/unmanned aerial vehicles and satellites.
When used as a radome (shield), it allows radar, antenna and communication systems to operate unaffected by harsh service conditions.
It ensures repeatable performance, minimal maintenance and long life in the field of use.
High transmission and low reflection in X-Band ensures that the incoming signal passes to the antenna with minimum loss and the antenna is supported with maximum protection against external factors.
It enables dielectric materials to be adapted to every application area where they are used.

### REFERENCES

[1] Fuat Berke GÜL, “SODYUM METABORAT DEKAHİDRAT (BORAKS) KATKILI PMMA POLİMER KOMPOZİTLERİN MİKRODALGA ÖZELLİKLERİNİN GELİŞTİRİLMESİ”, ITU M. Sc. Thesis, YOK Thesis Center, Thesis No: 672918, 2021. https://tez.yok.gov.tr/UlusalTezMerkezi/tezSorguSonucYeni.jsp
[2] Kenion, T., Yang, N., Xu, C. (2022). Dielectric and mechanical properties of hypersonic radome materials and metamaterial design: A review, Journal of the European Ceramic Society, Volume 42, Issue 1, Pages 1-17, ISSN 0955-2219, https://doi.org/10.1016/j.jeurceramsoc.2021.10.006.
[3] Kandi, K.K., Thallapalli, N. and Chilakalapalli, S. P. R. (2015), Development of Silicon Nitride-Based Ceramic Radomes—A Review. Int. J. Appl. Ceram. Technol., 12:909-920 https://doi.org/10.1111/ijac.12305.

What is claimed is:

1. A method of obtaining polymethylmethacrylate (PMMA)/Borax composite with modified hydrophilic properties, comprising process steps;
filling an Atmos-Bag with argon gas,
weighing of Tetra-n-butylammonium Bromide, Copper Bromide, Borax Decahydrate, Methyl Methacrylate, Pentamethyldiethylenetriamine, Ethyl 2-bromoisobutyrate chemicals with a precision scale in the Atmos-Bag,
comprising process steps;
mixing crystalline Borax Decahydrate and monomer Methyl Methacrylate in a first Atmos-Bag to obtain a first mixture,
adding the Tetra-n-butylammonium Bromide as solvent and the Copper Bromide as catalyst into the first mixture of the crystalline Borax Decahydrate and the monomer Methyl Methacrylate and stirring in the first Atmos-Bag to obtain a second mixture,
removing the second mixture from the first Atmos-Bag and transferring the second mixture to a second Atmos-Bag filled with argon gas,
adding pentamethyldiethylenetriamine ligand,
applying the argon gas to a solution with a syringe for 30 minutes to carry out a purification process to obtain a third mixture,
adding Ethyl 2-bromoisobutyrate reaction initiator to the third mixture,
stirring until polymerization is complete using a magnetic stirrer and bar to ensure effective stirring during reaction,
obtaining PMMA/Borax composite polymer as a result of polymerization process.

2. The method according to claim 1, wherein the PMMA/Borax composite exhibits a dielectric coefficient of 2.4-3.0 in a 500 MHz-50 GHz band range.

3. The method according to claim 1, wherein the PMMA/Borax composite obtained is configured used for radome purposes.
